(19) United States
(12) Patent Application Publication
(10) Pub. No.: US 2019/0269081 A1
(43) Pub. Date: Sep. 5, 2019

(54) Hydroponic Tower Compatible Plant Container

(71) Applicant: MJNN, LLC, South San Francisco, CA (US)

(72) Inventors: John Whitworth, Mountain View, CA (US); Loren Pilorin, Palo Alto, CA (US); Taylor Brooke Wollert, Lingle, WY (US); Michael Flynn, Palo Alto, CA (US); Alexandre Le Roux, Menlo Park, CA (US); Damon Henry Smith, Laramie, WY (US); Mark Cuson, Los Altos, CA (US)

(73) Assignee: MJNN, LLC, South San Francisco, CA (US)

(21) Appl. No.: 15/910,445

(22) Filed: Mar. 2, 2018

Related U.S. Application Data
(63) Continuation-in-part of application No. 15/910,308, filed on Mar. 2, 2018.

(51) Int. Cl. A01G 31/06

(52) U.S. Cl. CPC A01G 31/06

(57) ABSTRACT

A plant container is provided which is designed to be inserted within a cut-out in a hydroponic tower. The plant container includes (i) a plant cup configured to hold a plant's root structure along with a small portion of plant growth media; (ii) a pair of side wings extending from the sides of the plant cup, the side wings helping to direct water and nutrients to the plant roots contained within the plant cup; (iii) at least one handling rail that aids plant container insertion and removal, and which may include an alignment surface that insures that the plant container is fully inserted and aligned during the insertion procedure; and (iv) a fastener configured to hold the plant container within the tower cut-out.

### CROSS-REFERENCE TO RELATED APPLICATION

This application is a continuation-in-part of U.S. patent application Ser. No. 15/910,308, filed 2 Mar. 2018, the disclosure of which is incorporated herein by reference for any and all purposes.

### FIELD OF THE INVENTION

The present invention relates generally to hydroponic growing systems and, more particularly, to a plant container configured to simplify and expedite the insertion and removal of plants within a hydroponic tower.

### BACKGROUND OF THE INVENTION

The continued growth of the world's population is increasingly taxing the ability of conventional farms to adequately feed everyone. In an attempt to ease this crisis, in recent decades there has been an increased use of pesticides and fertilizers. Unfortunately this dependence on pesticides and fertilizers has exacerbated the problem, leading to regions that are less favorable to farming and, in some instances, creating dead zones in waterways subject to runoff.

Since population centers and agricultural centers are frequently not co-located, and due to the time and expense associated with shipping agricultural goods, in many regions of the world only the wealthy are able to obtain adequate supplies of non-processed food, i.e., raw fruits and vegetables. Furthermore, the fruits and vegetables that do reach population centers are likely to be of decreased nutritional content and flavor, both due to the distance that they have traveled and the fact that much of today's produce is bred for durability and fertility rather than flavor & nutrition. As a result, there has been a renewed interest in soilless growing techniques that do not require the use of pesticides, drastically reduce the use of water, and allow for growing varietals that are bred for nutrition and flavor instead of durability.

Hydroponics is a soilless growing technique in which plants are grown using a liquid solution of water and nutrients. The roots of the plants are typically maintained in a fibrous or granular material, often comprised of plastic, and fed via a wick, drip, nutrient film, or other nutrient delivery system. Hydroponic growing systems are often established within indoor facilities, thus allowing them to be located in or near population centers. This approach also provides exceptional climate control (i.e., temperature, humidity, air flow, CO₂ concentration, light wavelength, intensity and duration, etc.) as well as improved pest and disease control, thus allowing an indoor hydroponic farm to succeed in a region in which the outside environment and/or the soil conditions are inhospitable to the use of conventional farming techniques. Furthermore, hydroponic and other soilless growing techniques can yield extremely high plant densities, especially in those instances in which either horizontal stacking systems or vertical growth towers are used.

While hydroponic farming techniques offer a number of advantages over conventional farming techniques, in order to achieve large-scale adoption of these techniques it is vital that the cost per plant be competitive with the costs associated with conventional farming techniques. Accordingly, the present invention provides a means of simplifying and expediting the process by which plants may be inserted and/or removed from a hydroponic tower.

### SUMMARY OF THE INVENTION

The present invention provides a plant container configured to be inserted within a cut-out in a hydroponic tower. The plant container is comprised of (i) a plant cup, (ii) a pair of side wings, (iii) a handling rail, and (iv) a fastener configured to hold the plant container within the tower cut-out. The fastener may be comprised of a detent fastener configured to interact with an edge of the tower cut-out. The plant container, which may be fabricated as a single unit, is preferably fabricated from a plastic material (e.g., polyethylene, polypropylene, polyvinyl chloride, polytetrafluoroethylene, and acrylonitrile butadiene styrene, etc.).

The plant cup is configured to contain a plant root structure as well as a growth medium. Once the plant container is fully inserted into the tower, the plant cup's central axis is angled upwards to aid plant growth, where the angle is preferably in the range of 30 to 60 degrees off horizontal; more preferably where the angle is in the range of 40 to 50 degrees off horizontal; and still more preferably where the angle is set at approximately 45 degrees off horizontal. The front open face of the plant cup is proximate to the front surface of the hydroponic tower when the plant container is fully inserted into the tower cut-out.

In order to allow water and nutrients passing down the inside of the tower to reach the plant roots, a plurality of apertures is integrated into the plant cup. Preferably a portion of the apertures are located on an upper plant cup surface; a portion of the apertures are located on a lower plant cup surface; a portion of the apertures are located on a first plant cup side surface; and a portion of the apertures are located on a second plant cup side surface.

The pair of side wings is comprised of a first side wing extending from a first side of the plant cup and a second side wing extending from a second side of the plant cup, where both side wings are configured to promote passage of the water/nutrient mix through the apertures integrated into the plant cup. The side wings may slope downwards towards the sides of the plant cup, for example at an angle of 10 to 45 degrees. Each side wing may include one or more apertures that allow a portion of the water/nutrient mix landing on each side wing to pass downward through the wing and past the plant container.

The plant container includes at least one handling rail that is proximate to the plant cup's open front face. The handling rail includes at least one gripping surface that extends away from the front surface of the hydroponic tower when the plant container is inserted into the tower, thereby providing the user with a readily accessible handle to use during container insertion and removal. Preferably the handling rail includes an alignment surface that lies flat against the front surface of the hydroponic tower when the plant container is fully inserted into the tower cut-out. The plant container may further include a pair of handling tabs that extend away from the front surface of the plant container, thus providing further aid in plant container insertion and removal. The handling tabs may be located above and below the open front face of the plant cup.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a front view of an exemplary hydroponic tower for use with the plant container of the invention;

FIG. 2 provides a perspective view of a portion of the tower shown in FIG. 1;

FIG. 3 provides a perspective top view of a preferred embodiment of a plant container in accordance with the invention;

FIG. 4 provides a perspective bottom view of the plant container shown in FIG. 3;

FIG. 5 provides a front view of the plant container shown in FIGS. 3 and 4;

FIG. 6 provides a top planar view of the plant container shown in FIGS. 3-5;

FIG. 7 provides a bottom planar view of the plant container shown in FIGS. 3-6; and

FIG. 8 provides a detailed cross-sectional view of the plant container detent fastener.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

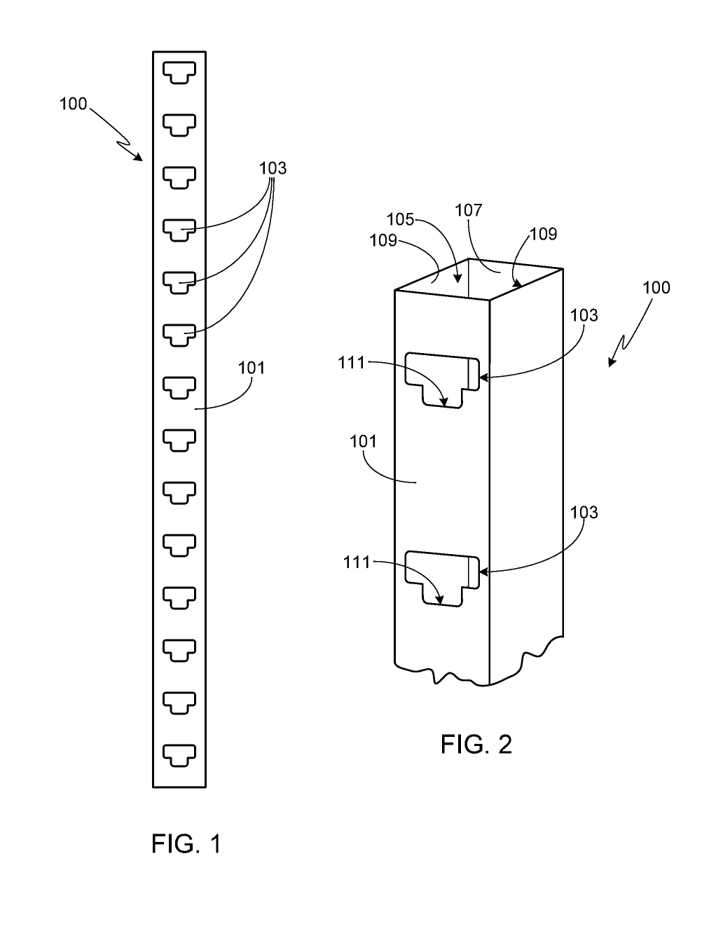

FIG. 1 provides a view of the front surface 101 of an exemplary hydroponic tower 100. Tower 100 is preferably extruded, although other fabrication techniques may be used in its manufacture. Preferably tower 100 is fabricated from plastic (e.g., polyethylene, polypropylene, polyvinyl chloride, polytetrafluoroethylene, etc.), although it can also be fabricated from metal (e.g.; aluminum) or other material. As fabricated, the tower is hollow. In the preferred embodiment, each side wall is tapered with a tapering angle of 4 degrees. In this embodiment, the front as well as each side wall is approximately 2 inches wide. It should be understood that the invention is equally applicable to towers of other dimensions (e.g., 3×3 inches, etc.) and other configurations (e.g., 3 inches wide by 2 inches deep, etc.). Typical tower heights range from 6 feet to 10 feet, although other heights may be used. In general, the height selected for a particular hydroponic tower is based on (i) the size of the facility housing the tower, (ii) the means used to access the tower during planting, plant monitoring and harvesting, and (iii) achieving the desired level of consistency in plant growth throughout the entire tower.

The front surface 101 of tower 100 includes a plurality of cut-outs 103 into which the individual plant containers fit as described in detail below. FIG. 2 provides a perspective view of a portion of tower 100 and a pair of cut-outs 103. The hollow portion 105 of the tower is used to deliver water and nutrients to the plants contained within the individual plant containers. In the preferred configuration, the water/nutrient mix is directed towards the tower's rear inner surface 107. Preferably the water/nutrient mix flows down surface 107, feeding the plants contained in the individual plant containers fit into each cut-out 103. The flow of the water/nutrient mix into the plant containers is described further below.

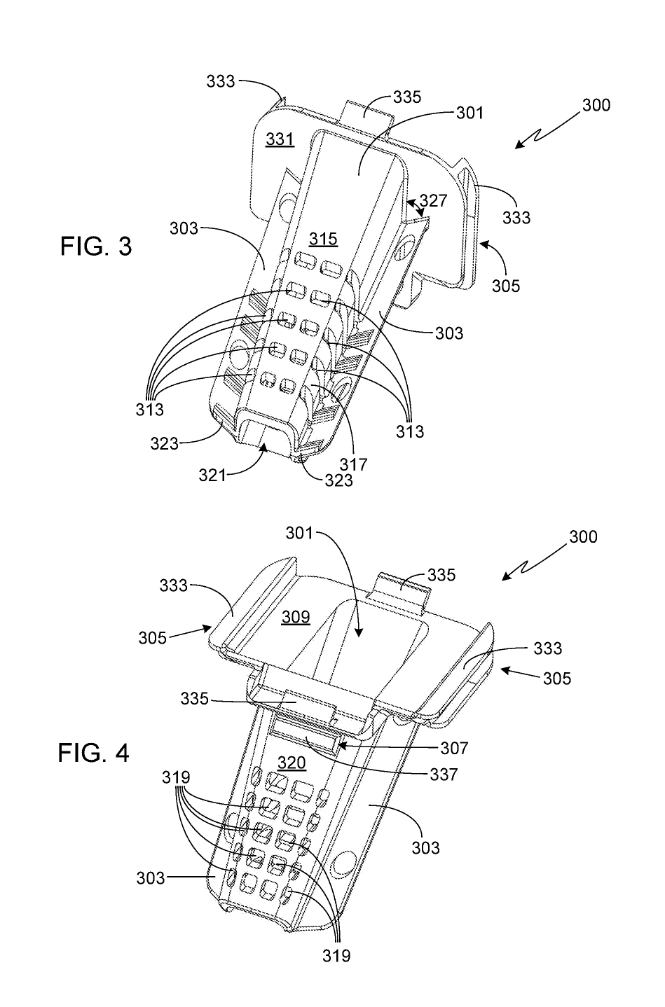

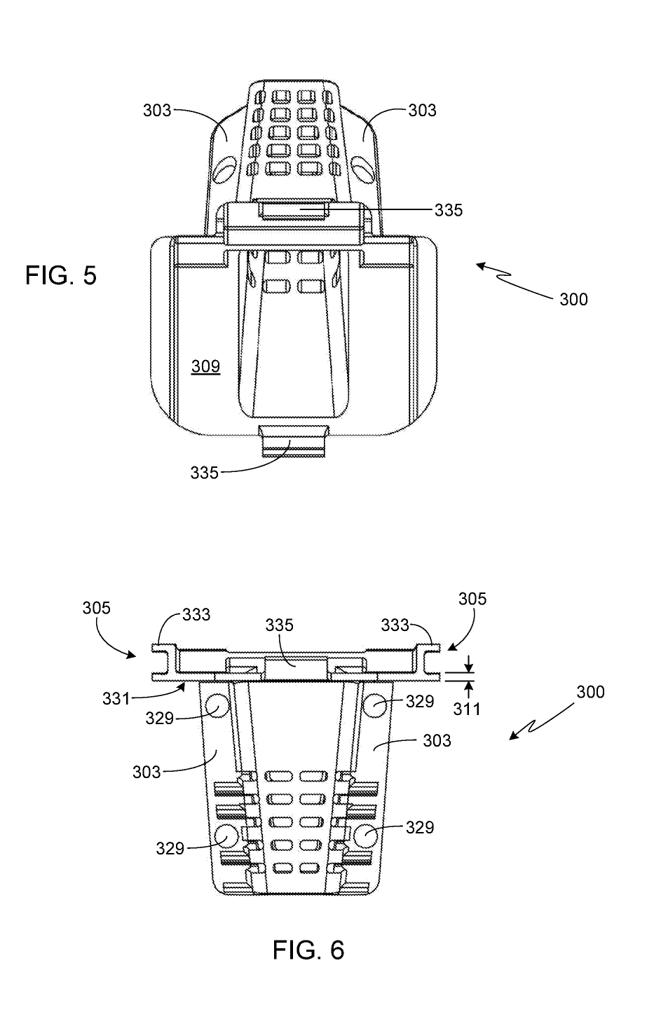

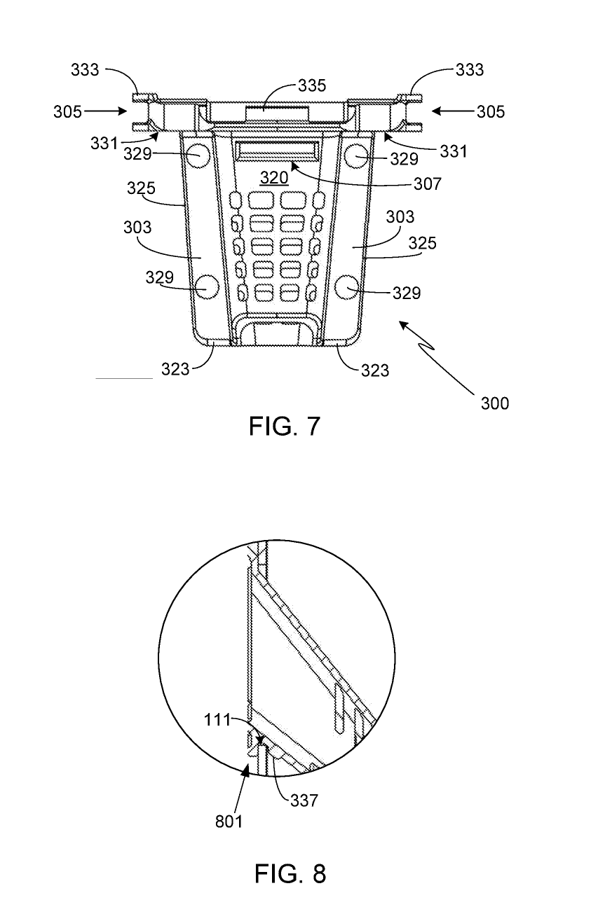

FIGS. 3 and 4 provide perspective top and bottom views of a preferred embodiment of a plant container 300. FIGS. 5-7 provide other views of plant container 300, including a top planar view (FIG. 6) and a bottom planar view (FIG. 7). FIG. 8 provides a cross-section of plant container 300 integrated into tower 100.

In accordance with the invention, each plant container is comprised of four primary sections, specifically (i) a plant cup 301, (ii) a pair of side wings 303, (iii) one or more handling rails 305, and (iv) a fastening member 307. Preferably each plant container 300 is fabricated, for example using injection molding, as a single piece. In the preferred embodiment, plant container 300 is manufactured from plastic (e.g., polyethylene, polypropylene, polyvinylchloride, polytetrafluoroethylene, acrylonitrile butadiene styrene (ABS), etc.). Plastic is the preferred material due to material cost, fabrication cost, and final component weight, although it should be understood that the plant container can be fabricated using other techniques and materials (e.g., metal, biodegradable materials, etc.). In the preferred embodiment, the plastic material used for the plant container is colored white in order to increase the amount of light reflected back onto the plants.

Plant cup 301 is configured to hold a plant, specifically a plant's root structure, along with a small amount of plant growth media (e.g., soil, coconut coir, etc.). When the plant container 300 is mounted within the hydroponic tower, preferably the front face of cup 301 extends slightly away from the front tower surface 101. In the illustrated embodiment, front face 309 extends out in front of tower surface 101 by the thickness 311 of face 309.

While the size of the opening in the front face 309 of plant cup 301 is primarily limited by the width of tower 100, the inventors have found that it is generally desirable to have an opening that is less than 1 inch in either dimension. In the embodiment illustrated in FIGS. 3-8, the opening of plant cup 301 is 0.75 inches by 0.75 inches.

As shown in the figures, plant cup 301 includes a plurality of openings 313 that allow water and nutrients passing down the inside of the tower to feed the contained plant. Preferably these apertures are located on the top surface 315 as well as the side surfaces 317 of the plant cup. Additional apertures 319 are included on bottom container surface 320, thus insuring that the water entering the plant cup can pass through the cup.

In addition to providing flow pathways for the water/nutrient mix, upper surface openings 313, and in particular lower surface openings 319, provide room for the plant's roots to grow. Providing room for root growth, and especially downward root growth, helps to prevent the tower from becoming packed with roots which, in turn, could prevent adequate levels of water and nutrients from reaching the plants located near the bottom of the tower. Besides providing necessary water/nutrient flow pathways, openings 313 and 319 also decrease the amount of material required per plant container, thereby lowering both material cost and component weight.

While openings 313 are not required by the invention to be of a particular size or shape, the inventors have found that by extending the openings located on the sides 317 of the plant cup down to the upper surface of side wings 303 as illustrated, water and nutrients that land on the side wings are directed to the plant roots.

The rear opening 321 of plant cup 301 may be completely open as shown. Alternately, rear opening 321 may only be partially open, thus helping to hold the plant and soil within plant cup 301 during insertion into the tower. To achieve a partially open rear opening, cross-members may be fabricated into the rear opening, where the number of cross-members may range from one or two to a lattice-like grid structure.

Extending from the side surfaces 317 of plant cup 301 are side wings 303. The side wings help to capture water and nutrients passing down the inside of the hydroponic tower and direct the water/nutrient mix to the plant via openings 313 as well as to the rear inner tower surface. To insure an efficient water/nutrient transfer system, when plant container 300 is inserted into tower 100, the rear edges 323 of the side wings are proximate to, and preferably in contact with, the inner rear surface 107 of the tower. Side edges 325 extend outwards toward the inside side surfaces 109 of the tower.

Although not required, preferably side wings 303 are sloped downwards towards the sides of plant cup 301 (see angle 327 in FIG. 3), thereby directing the water/nutrient mix that lands on the side wings towards the plant cup openings 313. If the side wings are sloped, preferably each side wing is angled downwards towards the plant cup with an angle (measured off the horizontal) in the range of 10 degrees to 45 degrees.

In the preferred and illustrated embodiment of the plant container, each side wing includes one or more openings 329. Side wing openings 329 allow some of the water/nutrient mix landing on these surfaces to immediately flow downwards to lower plant containers, rather than being directed to the attached plant cup. This helps to prevent excessive wetting of the plant roots, especially for those plants located in the upper portion of the tower.

Located on at least one side of the plant container, and preferably located on both sides of the plant container, are handling rails 305. The handling rails simplify both insertion and removal of the plant container by providing a readily accessible handle for the user to grip. Preferably each handling rail 305 includes a flat alignment surface 331 that is designed to lay flat against external tower surface 101 when the plant container is fully inserted into the tower, thus providing a depth gauge during container insertion. Additionally, requiring that surface 331 lie flat against the tower face when the container is fully inserted insures that the plant cup 301 is at the desired angle. When the plant container is properly located within the hydroponic tower, the central axis of plant cup 301 is angled downwards as measured from the front to the rear of the plant cup. Preferably the angle of the plant cup is in the range of 30 to 60 degrees off horizontal, more preferably in the range of 40 to 50 degrees off horizontal, and still more preferably at an angle of 45 degrees off horizontal.

In addition to including alignment surface 331, each handling rail 305 also includes at least one gripping surface 333. Surfaces 333 extend away from alignment surface 331 as shown, thus insuring that even when the plant container is fully inserted into the hydroponic tower, the handle rails are still easily accessible and easily graspable via the gripping surfaces. In addition to the handling rails, the preferred embodiment of the plant container also includes two alignment tabs 335 located above and below the plant cup. While alignment tabs 335 can function as handling rails, in the illustrated embodiment they are used to align multiple plant containers stacked within a loading magazine.

In order to prevent the plant container from becoming dislodged from the tower, one or more fastening means are used. While there are numerous fasteners that can be used to hold the plant container in place, many of these unnecessarily increase the time it takes to couple and decouple the plant container from the tower. Accordingly, the preferred embodiment of the invention utilizes a single detent fastener 307 located on the bottom surface 320 of the plant cup 301. It will be appreciated that one or more detent fasteners could be included elsewhere on the plant container (e.g., side surfaces), and that the detent fastener could be replaced with a different type of fastener (e.g., a snap-fit fastener) that provides similar ease when coupling/de-coupling the plant container from the tower.

Due to the flexibility of the walls of the plant cup, when the plant container is inserted into the tower cut-out, the raised lip 337 is forced past the lower edge 111 of cut-out 103, thereby locking the plant container in place. A detailed cross-sectional view of detent fastener 307 is provided by FIG. 8, this view showing the plant container locked into the tower. Note that in this view, lip 337 is locked in place by cut-out edge 111. During container removal, a relatively small amount force applied at an upward angle 801 (see FIG. 8) is sufficient to dislodge the plant container. If the force is applied perpendicular to the face of the tower, similar to the force that would be applied by roots that build up behind the face of the plant container, the container remains locked in place.

In addition to providing a convenient means for inserting and removing plants in a hydroponic tower, it should be understood that the plant containers of the present invention can also be used to locate any of a variety of sensors within the tower. In such a scenario, a suitable sensor rather than a plant and soil is placed within the container's plant cup, thus allowing a variety of growing conditions to be monitored (e.g., moisture levels, nutrient concentrations, etc.).

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A plant container configured to be inserted within a cut-out in a hydroponic tower, the plant container comprising:
a plant cup configured to contain a plant root structure and a growth medium, wherein a central axis corresponding to said plant cup is angled upwards at an angle off horizontal when the plant container is fully inserted into the cut-out of the hydroponic tower, said plant cup comprising:
an open front face, wherein said open front face of said plant cup is proximate to a front surface of said hydroponic tower when the plant container is fully inserted into the cut-out of the hydroponic tower; and
a plurality of apertures configured to allow passage of a water/nutrient mix passing within said hydroponic tower to said plant root structure contained within said plant cup;
a first side wing extending from a first side of said plant cup, said first side wing configured to promote passage of said water/nutrient mix through a first portion of said plurality of apertures;
a second side wing extending from a second side of said plant cup, said second side wing configured to promote passage of said water/nutrient mix through a second portion of said plurality of apertures;
a handling member proximate to said open front face, said handling member comprising at least one gripping surface, wherein said at least one gripping surface extends away from said front surface of the hydroponic tower when the plant container is fully inserted into the hydroponic tower; and
a fastener configured to hold the plant container within the cut-out in the hydroponic tower.

2. The plant container of claim 1, said fastener further comprising a detent fastener configured to interact with an edge of the cut-out.

3. The plant container of claim 2, said detent fastener located on a bottom surface of said plant cup.

4. The plant container of claim 1, said handling member further comprising an alignment surface, wherein said alignment surface lies flat against said front surface of said hydroponic tower when the plant container is fully inserted into the cut-out of the hydroponic tower.

5. The plant container of claim 1, wherein a first gripping surface of said at least one gripping surface is proximate a first side of said open front face of said plant cup, and wherein a second gripping surface of said at least one gripping surface is proximate a second side of said open front face of said plant cup.

6. The plant container of claim 1, further comprising a pair of handling tabs, wherein each handling tab of said pair of handling tabs extends away from a front surface of said plant container.

7. The plant container of claim 6, wherein a first handling tab of said pair of handling tabs is proximate an upper side of said open front face of said plant cup, and wherein a second handling tab of said pair of handling tabs is proximate a lower side of said open front face of said plant cup.

8. The plant container of claim 1, said first portion of said plurality of apertures located on said first side of said plant cup, said second portion of said plurality of apertures located on said second side of said plant cup, a third portion of said plurality of apertures located on an upper surface of said plant cup, and a fourth portion of said plurality of apertures located on lower surface of said plant cup.

9. The plant container of claim 1, wherein said first side wing slopes downward towards said first side of said plant cup, and wherein said second side wing slopes downward towards said second side of said plant cup.

10. The plant container of claim 9, wherein said first side wing slopes downward towards said first side of said plant cup at a first angle in the range of 10 degrees to 45 degrees, and wherein said second side wing slopes downward towards said second side of said plant cup at a second angle in the range of 10 degrees to 45 degrees.

11. The plant container of claim 1, said first side wing further comprising at least one first side wing aperture, wherein said at least one first side wing aperture allows a first portion of said water/nutrient mix landing on said first side wing to pass downward through said first side wing and past said plant container, said second side wing further comprising at least one second side wing aperture, wherein said at least one second side wing aperture allows a second portion of said water/nutrient mix landing on said second side wing to pass downward through said second side wing and past said plant container.

12. The plant container of claim 1, wherein a rearmost edge of said plant cup contacts an inner surface of said hydroponic tower when the plant container is fully inserted into the cut-out of the hydroponic tower.

13. The plant container of claim 1, wherein said angle off horizontal of said central axis of said plant cup is in the range of 30 degrees to 60 degrees.

14. The plant container of claim 13, wherein said angle off horizontal of said central axis of said plant cup is in the range of 40 degrees to 50 degrees.

15. The plant container of claim 14, wherein said angle off horizontal of said central axis of said plant cup is approximately 45 degrees.

16. The plant container of claim 1, said plant container fabricated from a plastic material.

17. The plant container of claim 16, said plastic material selected from the group consisting of polyethylene, polypropylene, polyvinyl chloride, polytetrafluoroethylene, and acrylonitrile butadiene styrene.

18. The plant container of claim 16, wherein said plastic material is white.

19. The plant container of claim 1, said plant container fabricated as a single piece.
